(19) United States
(12) Patent Application Publication
(10) Pub. No.: US 2007/0192108 A1
(43) Pub. Date: Aug. 16, 2007

(54) System and method for detection of emotion in telecommunications

(76) Inventor: Alon Konchitsky, Sunnyvale, CA (US)

Correspondence Address: STEVEN A. NIELSEN;ALLMAN & NIELSEN, P.C, 100 Larkspur Landing Circle, Suite 212, LARKSPUR, CA, 94939, US

(21) Appl. No.: 11/675,207

(22) Filed: Feb. 15, 2007

Related U.S. Application Data
(60) Provisional application No. 60/766,859, filed on Feb. 15, 2006.

(51) Int. Cl. G10L 21/00

(52) U.S. Cl. 704/270

(57) ABSTRACT

A system and method monitor the emotional content of human voice signals after the signals have been compressed by standard telecommunication equipment. By analyzing voice signals after compression and decompression, less information is processed, saving power and reducing the amount of equipment used. During conversation, a user of the disclosed methodology may obtain information in visual format regarding the emotional state of the other party. The user may then assess the veracity, composure, and stress level of the other party. The user may also view the emotional content of his own transmitted speech.

### CROSS-REFERENCE TO RELATED APPLICATIONS

This application claims the benefit of the provisional patent application 60/766,859 filed on Feb. 15, 2006 which is incorporated herein by reference.

### STATEMENT REGARDING FEDERALLY SPONSORED RESEARCH OR DEVELOPMENT

Not Applicable

### REFERENCE TO A SEQUENCE LISTING

Not Applicable

### BACKGROUND OF THE INVENTION

(1) Field of the Invention

The invention relates to means and methods of measuring the emotional content of a human voice signal while the signal is in a compressed state.

(2) Description of the Related Art

Several attempts to monitor emotions in voice signals are known in the related art. However, the related art fails to provide the advantages of the present invention, which include means of measuring emotions in a compressed voice signal.

U.S. Pat. No. 6,480,826 to Pertrushin extracts an uncompressed voice signal, assigns emotional values to the extracted signals, and reports the emotion. U.S. Pat. No. 3,855,416 to Fuller measures emotional stress in speech by analyzing the presence of vibrato or rapid modulation. Neither Pertrushin nor Fuller disclose means of analyzing the emotional content of compressed voice signals. Thus, there is a need in the art for means and methods of analyzing the emotional content of compressed telecommunication signals.

### BRIEF SUMMARY OF THE INVENTION

The present invention overcomes shortfalls in the related art by providing means and methods of analyzing the emotional content of compressed telecommunication signals. Today, most telecommunication signals undergo compression, which often occurs within the handset of the user. The invention takes advantage of the compressed nature of the signal to achieve new efficiencies in power consumption and hardware costs to sample less data after compression as compared to the prior art sampling of noncompressed data.

In a typical modern wireless telecommunications system a voice signal may be compressed from approximately 64 kb to 10 kb per second. Due to the lossly compression methods typically used today, not all information is transferred into the compressed voice signal. To accommodate the loss of data, novel signal processing techniques are used to improve signal quality and to detect the transmitted emotion.

In a compressed voice signal, the invention, as implemented within a cell phone handset, measures the fundamental frequency of the parties of the conversation. Differences in pitch, tambour, stability of pitch frequency, volume, amplitude and other factors are analyzed to detect emotion and/or deception of the speaker.

Vocoder or other similar hardware may be used to analyze a compressed voice signal. After an emotion is detected, the emotional quality of the speaker may be visually reported to the user of the handset.

These and other objects and advantages will be made apparent when considering the following detailed specification when taken in conjunction with the drawings.

### BRIEF DESCRIPTION OF THE DRAWINGS

FIG. 1, from Fuller, is an oscillograph of a male voice responding with the word “yes” in the English language, in answer to a direct question at a bandwidth of 5 kHz.

FIG. 2, from Fuller is an oscillograph of a male voice responding with the word “no” in the English language in answer to a direct question at a bandwidth of 5 kHz.

FIGS. 3a and 3b, from Fuller are oscillgraphs of a male voice responding “yes” in the English Language as measured in the 150-300 Hz and 600-1200 Hz frequency regions, respectively.

FIGS. 4a and 4b, from Fuller are oscillographs of a male voice responding “no” in the English language as measured in the 150-300 Hz and 600-1200 Hz frequency regions, respectively.

FIG. 5 is a schematic diagram of a hardware implementation of one embodiment of the present invention wherein a vocoder is used for analysis of compressed voice signals.

FIG. 6 is a flowchart depicting one embodiment of the present invention that detects emotion using compressed voice signals after decompression.

### DETAILED DESCRIPTION OF THE INVENTION

In one embodiment of the invention, a system or device receives uncompressed voice signals, performs lossly compression upon the signal, extracts certain elements or frequencies from the compressed signal, measures variations in the extracted compressed components, assigns an emotional state to the analyzed speech, and reports the emotional state of the analyzed speech.

The invention also includes means to restore some data elements after the voice signal goes through lossly compression.

Hardware Overview

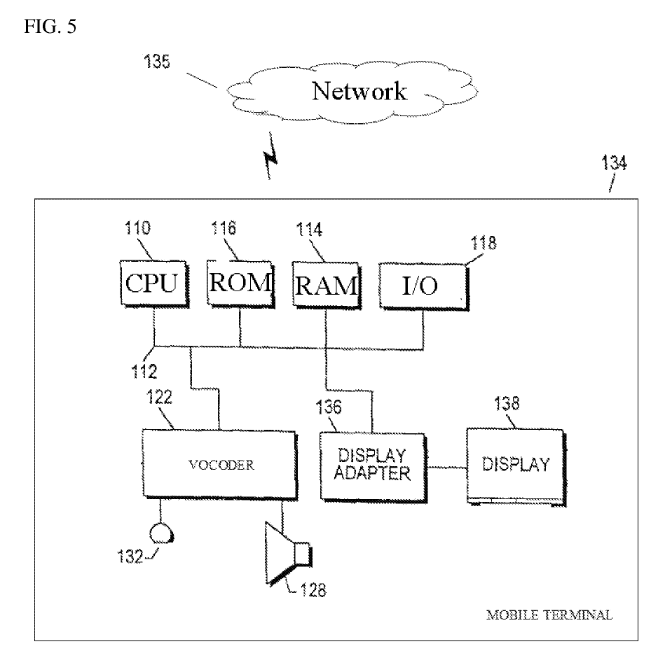

The analysis of compressed speech may occur in a vocoder 122 as implemented in FIG. 5. which illustrates a typical hardware configuration of a mobile device having a central processing unit 110, such as a microprocessor, and a number of other units interconnected via bus 112, and includes Random Access Memory (RAM) 114, Read Only Memory (ROM) 116, an I/O adapter 118 for connecting peripheral devices such as memory storage units to the bus 112, a voce coder (vocoder) that is the interface of speaker 128, a microphone 132, and a display adapter 136 for connecting the bus 112 to a display device or screen 138.

Other analogous hardware configurations are contemplated.

Methodology Overview

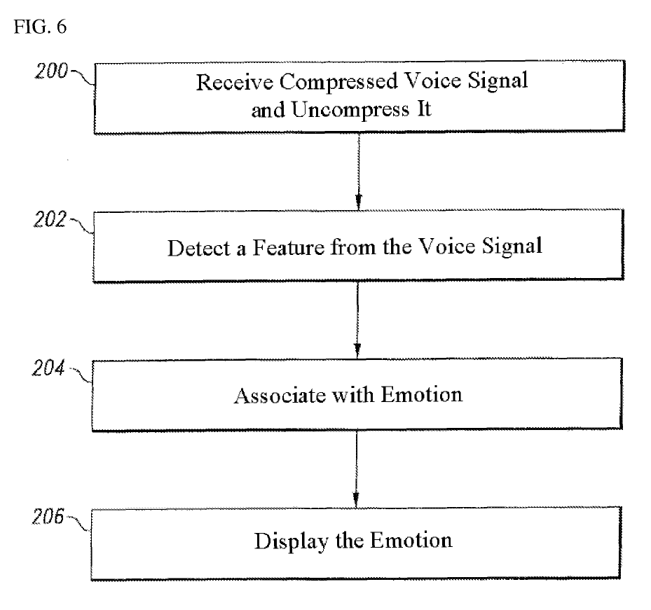

The steps of the disclosed method are outlined in FIG. 6, and include block 200 wherein the step of compression is added to achieve new economies of power consumption and efficiencies in utilizing existing hardware. Block 200 includes the step of decompression.

A telecommunication device, such as a cell phone or voice over internet protocol, or voice messenger, or handset may receive 200 a voice signal from a network or other source. Unlike the related art, the present invention then compresses the voice signal and then decompresses the voice signal before performing an analysis of emotional content. Block 200 may also include means using an efficient lossly compression system and means of recovering lost data elements.

At block 202 at least one feature of the uncompressed voice signal is extracted to analyze the emotional content of the signal. However, unlike Pertrushin, the extracted signal has been compressed and decompressed.

At block 204 an emotion is associated with the characteristics of the extracted feature. However, unlike Pertrushin, due to compression and decompression, less bandwidth needs to be analyzed as compared to the related art.

At block 206 the assigned emotion is conveyed to the user of the device.

Detailed Analysis of Improvements to the Related Art

After lossly compression, data reconstruction and/or decompression, streamlined extraction of data, selection of data elements to analyze, and other steps, the invention uses some of the known art to assign an emotional state to voice signal.

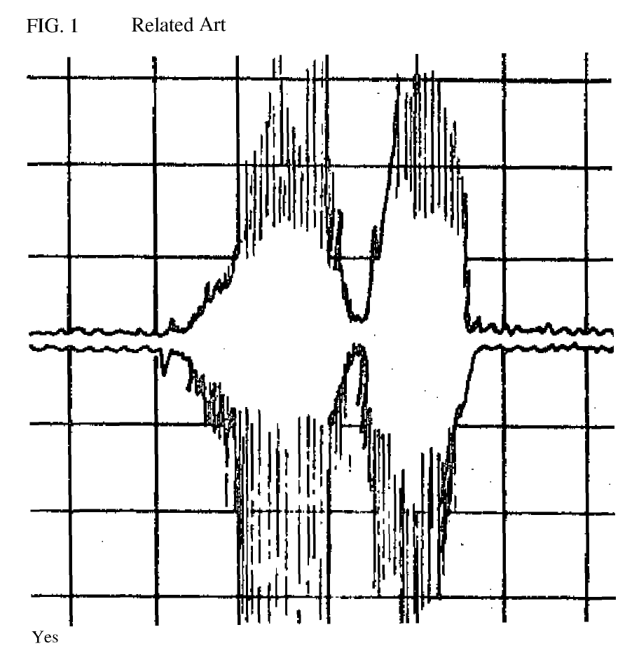

In one alternative embodiment, Fuller's technique from U.S. Pat. No. 3,855,416 may be used to analyze a voice signals' stress and vibrato content. FIGS. 1 to 4b from Fuller, as presented herein, demonstrate several basic principals of voice analysis, but do not address the use of compression and other methods as disclosed in the present invention.

After compression and decompression, traditional methods of emotion detection may be employed, such as the methods of Fuller, some of which are described herein.

Phonation and Formants

The definitions of “Phonation” and “Formants” are well stated in Fuller:

Speech is the acoustic energy response of: (a) the voluntary motions of the vocal cords and the vocal tract which consists of the throat, the nose, the mouth, the tongue, the lips and the pharynx, and (b) the resonances of the various openings and cavities of the human head. The primary source of speech energy is excess air under pressure, contained in the lungs. This air pressure is allowed to flow out of the mouth and nose under muscular control which produces modulation. This flow is controlled or modulated by the human speaker in a variety of ways.

The major source of modulation is the vibration of the vocal cords. This vibration produces the major component of the voiced speech sounds, such as those required when conus the vowel sounds in a normal manner. These voiced sounds, formed by the buzzing action of the vocal cords, contrast to the voiceless sounds such as the letter s or the letter f produced by the nose, tongue and lips. This action of voicing is known as “phonation.”

The basic buzz or pitch frequency, which establishes phonation, is different for men and woman. The vocal cords of a typical adult male vibrate or buzz at a frequency of about 120 Hz, whereas for women this basic rate is approximately an octave higher, near 250 Hz. The basic pitch pulses of phonation contain many harmonics and overtones of the fundamental rate in both men women.

The vocal cords are capable of a variety of shapes and motions. During the process of simple breathing, they are involuntarily held open and during phonation, they are brought together. As air is expelled from the lungs, at the onset of phonation, the vocal cords vibrate back and forth, alternately closing and opening. Current physiological authorities hold that the muscular tension and the effective mass of the cords is varied by learned muscular action. These changes strongly influence the oscillating or vibrating system.

Certain physiologists consider that phonation is established by or governed by two different structures in the pharynx, i.e., the vocal cord muscles and a mucous membrane called the cones elasticus. These two structures are acoustically coupled together at a mutual edge within the pharynx, and cooperate to produce two different modes of vibration.

In one mode, which seems to be an emotionally stable or non-stressful timbre of voice, the conus elasticus and the vocal cord muscle vibrate as a unit in synchronism. Phonation in this mode sounds “soft” or “mellow” and few overtones are present.

In the second mode, a pitch cycle begins with a subglottal closure of the conus elasticus. This membrane is forced upward toward the coupled edge of the vocal cord muscle in a wave-like fashion, by air pressure being expelled from the lungs. When the closure reaches the coupled edge, a small puff of air “explosively” occurs, giving rise to the “open” phase of vocal cord motion. After the “explosive” puff of air has been released, the subglottal closure is pulled shut by a suction which results from the aspiration of air through the glottis. Shortly after this, the vocal cord muscles also close. Thus in this mode, the two masses tend to vibrate in opposite phase. The result is a relatively long closed time, alternated with short sharp air pulses which may produce numerous overtones and harmonics.

The balance of respiratory tract and the nasal and cranial cavities give rise to a variety of resonances, known as “formants” in the physiology of speech. The lowest frequency format can be approximately identified with the pharyngeal cavity, resonating as a closed pipe. The second formant arises in the mouth cavity. The third formant is often considered related to the second resonance of the pharyngeal cavity. The modes of the higher order formants are too complex to be very simply identified. The frequency of the various formants vary greatly with the production of the various voiced sounds.

Vibrato

In testing for veracity or in making a Truth/Lie decision, the vibrato component of speech may have a very high correlation with the related level of stress or emotional state of the speaker. FIG. 1, from Fuller is an oscilloghraph of a male voice stating “yes” at a bandwidth of 5 kHz. As pointed out by Fuller:

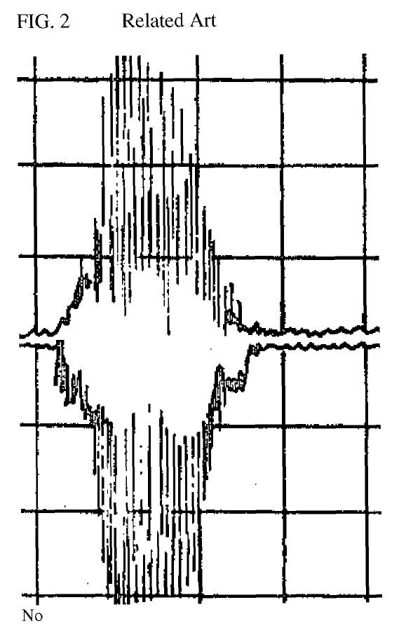

The wave form contains two distinct sections, the first being for the “ye” sound and the second being for the unvoiced “s” sound. Since the first section of the “yes” signal wave form is a voiced sound being produced primarily by the vocal cords and conus elasticus, this portion will be processed to detect emotional stress content or vibratto modulation. The male voice responding with the word “no” in the English language at a bandwidth of 5 kHz is shown in FIG. 2.

The single voiced section may be analyzed to measure the vibrato of the phonation constituent of the speech signal.

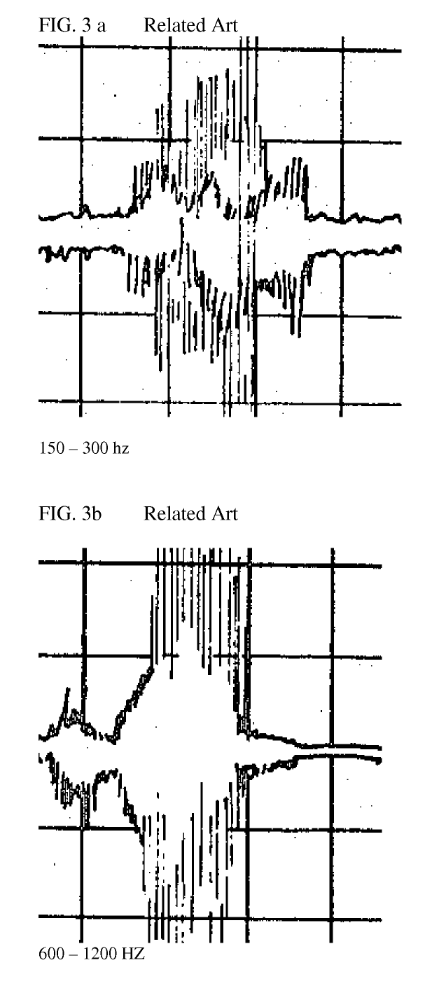

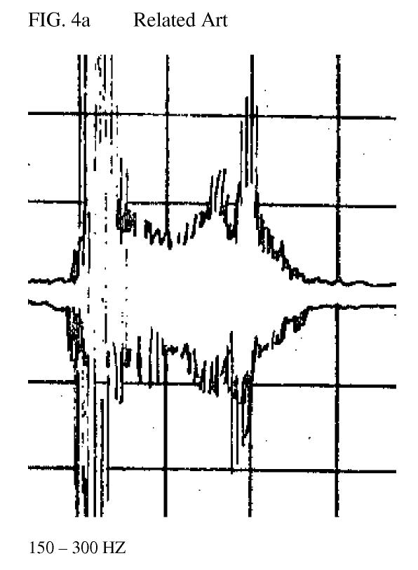

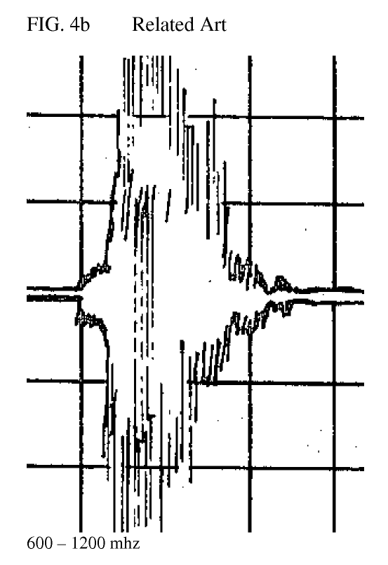

The spectral region of 150-300 Hz comprises a significant amount of the fundamental energy of phonation. FIGS. 3 and 4 from Fuller, as presented herein, show an oscillograph of the same voice in FIGS. 1 and 2 as measured in the 150-300 Hz frequency region.

Advantages of Compression in Relation to Relevant Frequencies or “Formants” Generated by Human Speech

Pertrushin identifies three significant frequency bands of human speech and defines these bands as “formants”. While Pertrushin describes a system to use the first formant band of the top end of the fundamental “buzz” frequency of 240 Hz to approximately 1000 Hz, Pertrushin fails to even consider the need of efficiently extracting the useful bandwidths of speech sounds. By use of the present invention, signal compression and other techniques are used to efficiently extract the most useful “formants” or energy distributions of human speech.

Pertushin gives a good general overview of the characteristics of human speech, stating:

Human speech is initiated by two basic sound generating mechanisms. The vocal cords; thin stretched membranes under muscle control, oscillate when expelled air from the lungs passes through them. They produce a characteristic “buzz” sound at a fundamental frequency between 80 Hz and 240 Hz. This frequency is varied over a moderate range by both conscious and unconscious muscle contraction and relaxation. The wave form of the fundamental “buzz” contains many harmonics, some of which excite resonance is various fixed and variable cavities associated with the vocal tract. The second basic sound generated during speech is a pseudo-random noise having a fairly broad and uniform frequency distribution. It is caused by turbulence as expelled air moves through the vocal tract and is called a “hiss” sound. It is modulated, for the most part, by tongue movements and also excites the fixed and variable cavities. It is this complex mixture of “buzz” and “hiss” sounds, shaped and articulated by the resonant cavities, which produces speech.

In an energy distribution analysis of speech sounds, it will be found that the energy falls into distinct frequency bands called formants. There are three significant formants. The system described here utilizes the first formant band which extends from the fundamental “buzz” frequency to approximately 1000 Hz. This band has not only the highest energy content but reflects a high degree of frequency modulation as a function of various vocal tract and facial muscle tension variations.

In effect, by analyzing certain first formant frequency distribution patterns, a qualitative measure of speech related muscle tension variations and interactions is performed. Since these muscles are predominantly biased and articulated through secondary unconscious processes which are in turn influenced by emotional state, a relative measure of emotional activity can be determined independent of a person's awareness or lack of awareness of that state. Research also bears out a general supposition that since the mechanisms of speech are exceedingly complex and largely autonomous, very few people are able to consciously “project” a fictitious emotional state. In fact, an attempt to do so usually generates its own unique psychological stress “fingerprint” in the voice pattern.

Thus, the utility of efficiently extracting only the relevant formants or frequency distributions is evident. The use of compression and other methods, as disclosed herein are well suited to take advantage of the relatively narrow bandwidths of relevant frequencies.

What is claimed is:

1. A method of detecting the emotional content in compressed voice signals comprising the steps of:
(a) receiving compressed voice signal;
(b) uncompressing the voice signal;
(c) from the uncompressed signal, measuring the fundamental frequency of the user for variations in frequency;
(d) assigning an emotional state to the measured frequency; and
(e) reporting the measured emotional state.

2. The method of claim 1, including the measurement of tambour.

3. The method of claim 1, including the measurement of volume.

4. The method of claim 1, including the measurement of amplitude.

5. The method of claim 1, including the use of lossly compression.

6. The method of claim 5, including the reconstruction of lost data after compression.

7. A device for detecting the emotional content in compressed voice signals comprising:
(a) means of receiving an uncompressed voice signal;
(b) means of compressing a voice signal;
(c) means of analyzing the emotional content of the compressed voice signal;
(d) means of assigning an emotional state to the analyzed compressed voice signal; and
(e) means of reporting the assigned emotional state.

8. The device of claim 7 wherein a vocoder is used to measure the emotional state of the compressed voice signal.

9. The device of claim 7 with means to use lossly compression.

10. The device of claim 9 with means to restore lost data after lossly compression.

11. The device of claim 10 that includes a mobile hand set.

12. The device of claim 111 that includes a screen to display the emotional content of the received speech.

13. The device of claim 12 that includes means to measure the emotional content of the user's speech.

14. The device of claim 13 that includes means to display to the user the emotional content of the speech being transmitted.

15. The device of claim 14 that includes means to remove the emotional content of transmitted speech.
